(19) United States
(12) Patent Application Publication
(10) Pub. No.: US 2021/0170616 A1
(43) Pub. Date: Jun. 10, 2021

(54) Razor

(71) Applicants: Benjamin Avery, Oakland, CA (US); Anton Fahlgren, San Francisco, CA (US)

(72) Inventors: Benjamin Avery, Oakland, CA (US); Anton Fahlgren, San Francisco, CA (US)

(21) Appl. No.: 17/181,857

(22) Filed: Feb. 22, 2021

Related U.S. Application Data
(63) Continuation of application No. 16/579,273, filed on Sep. 23, 2019.

(51) Int. Cl. B26B 21/52; B26B 21/22

(52) U.S. Cl. CPC B26B 21/521; B26B 21/222; B26B 21/522

(57) ABSTRACT

Described is a razor with a removable cartridge. The handle may be ergonomically designed, and the cartridge may be held in place with magnetic components, which may be situated around the periphery of the cartridge or may be configured in a Halbach array arrangement.

### TECHNICAL FIELD

The instant disclosure relates to a razor or similar apparatus, wherein the razor is configured to provide enhanced shaving performance as well as an improved user experience.

### BACKGROUND

There are currently several types of razors on the market. Traditional straight razors in which a razor blade is contained within a housing that, in turn, includes a handle that a user manipulates to guide the razor blade against the skin surface have been popular among users. While simple in structure, these razors have been difficult for many to use as they require a certain amount of dexterity to successfully remove hair from the skin surface without injury. After repeated use, the razor blade may need to be replaced. Users traditionally needed to carefully remove the razor blade and replace it with a new razor blade. This activity was considered by many users to be dangerous as the user may sustain injuries through handling the razor blades while changing them.

Many users use a disposable razor in which at least one razor blade is contained within a structure that includes a handle, much like the traditional straight razor. However, with the disposable razor, when the user is no longer satisfied with the performance of the razor, the user may discard the razor in its entirety. While considered by some to be convenient, the disposable razor results in increased waste. In addition, many disposable razors are constructed by material that cannot be recycled. This negative impact on the environment has become a deterrent to many users to using this type of razor. Also, disposable razors typically contain a limited number of razor blades which negatively impacts the performance of these razors.

Cartridge razors are another type of razor in which at least one razor blade is contained in a housing (the “cartridge”) that is detachable from a handle. The cartridge is connected to the handle via snap features in which the handle contains a tab at one end that inserts into an opening in the cartridge. The user applies pressure to push the tab of the handle into the opening of the cartridge. This pressure activates a mechanical locking mechanism in the cartridge in which a connecting portion moves over the inserted tab to mechanically lock the handle in place. When the user wishes to dispose of the razor blade, the user may detach the cartridge from the handle by pressing a release mechanism that releases the connecting portion of the cartridge by physically opening the connecting portion to mechanically release the handle (or the tab). In this way, the user may replace the cartridge with another (newer) cartridge by reconnecting the newer cartridge to the handle using the same mechanical locking mechanism. In this way, less waste is produced as only the portion of the housing that contains the razor blade is discarded while the handle is preserved and reused. The cartridge razor has various disadvantages, such as excessive stress applied repeatedly to the mechanical locking mechanism causing the mechanism to fail or intricacies of the locking mechanism causing difficulty in proper cleaning of the entire structure, for example.

It is desirable to devise a razor that is not only ergonomically designed but also connects a razor blade to a handle in an efficient way that minimizes stress, prolongs the life of the razor, and provides ease in cleaning and maintenance.

### SUMMARY

The technology discussed herein relates to a device for shaving, including a handle and at least one razor blade. In one example, the device comprises a cartridge, the cartridge being removably attachable to a handle component. The cartridge may further contain one or more magnetic components or a plurality of magnetic components. The magnetic components may be arranged in a variety of configurations within the cartridge. For example, the plurality of magnetic components may be situated around the periphery of the cartridge or may be configured in a Halbach array arrangement.

The device may further include a handle that may be removably attached to the cartridge. The handle may further include a portion that corresponds in shape with the cartridge. For example, the cartridge and the portion of the handle may be circular, rectangular, ovoid, or loop-shaped. The handle portion may further include at least one magnetic component. The at least one magnetic component may be positioned within the portion of the handle in a similar configuration to the positioning of an at least one ferrous metal component of the cartridge. The handle may further include an alignment structure for connecting to and aligning the positioning of the cartridge. In one example, the alignment structure may distribute applied forces. In one non-limiting example, the alignment structure may include a spring that distributes applied forces in a horizontal orientation relative to the cartridge.

The device may also include an insert that may be inserted into a portion of the handle. The insert may further include at least one magnetic component. In one example, the at least one magnetic component may be positioned within the insert in a configuration that corresponds to the configuration of the at least one ferrous metal component in the cartridge.

### BRIEF DESCRIPTION OF THE DRAWINGS

FIG. 1 illustrates an example of a razor including a handle and at least one razor blade according to one embodiment.

FIG. 2 illustrates an example of a partially assembled view of a razor according to one embodiment.

FIG. 3 illustrates components of a razor, according to one embodiment.

FIG. 4 illustrates a perspective view of an example of a razor according to one embodiment.

FIG. 5 illustrates a potential flow of water or air to assist in cleaning hair from a razor, according to one embodiment.

FIG. 6 illustrates another view of a partially assembled razor, according to one embodiment.

FIG. 7 illustrates another view of a partially assembled razor, according to one embodiment.

### DETAILED DESCRIPTION

In the following detailed description, specific details are set forth by way of examples. However, it should be apparent to those skilled in the art that the instant disclosure is not so limited and that the instant disclosure includes modifications to the specific examples described herein without departing from the spirit and scope.

In one example, a razor or similar device is described that may include at least one razor blade or other sharp-edged component. The at least one razor blade may be used to remove hair from a skin surface. The at least one razor blade may be contained within a housing component, such as a cartridge, that attaches to a handle. After attaching the housing component or cartridge to the handle, a user may move the device by holding and moving the handle, thereby moving the attached housing component or cartridge and the razor blade(s) contained therein.

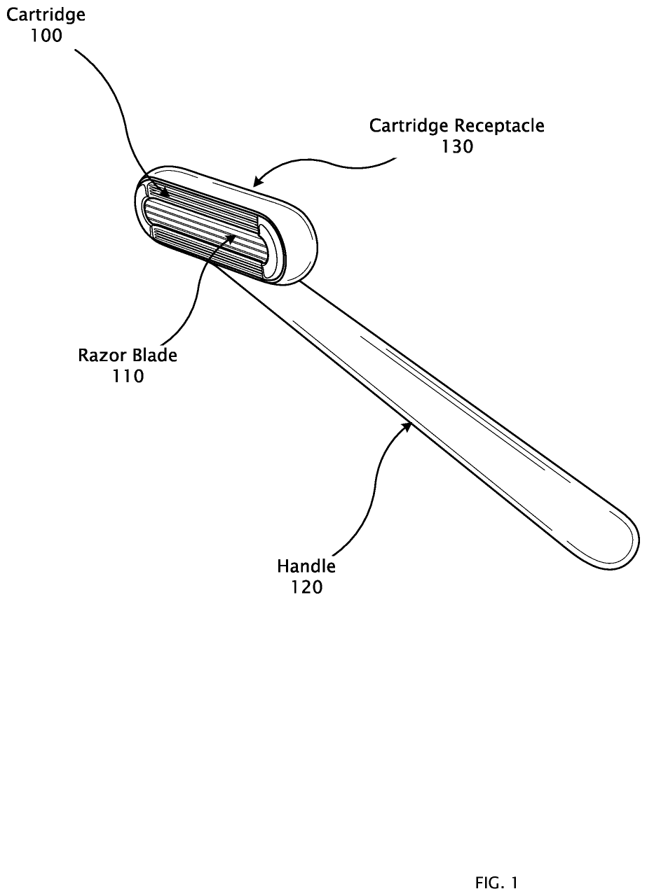

FIG. 1 illustrates one example of a razor. In this example, a housing component or Cartridge 100 may contain at least one Razor Blade 110. The at least one Razor Blade 110 may contain a sharp edge on one aspect of Razor Blade 110, such as a leading edge. The at least one Razor Blade 110 may also contain a sharp edge on another aspect of Razor Blade 110, such as the trailing edge. Any aspect of Razor Blade 110 may contain a sharp edge. In addition, Cartridge 100 may contain one Razor Blade 110 or may contain a plurality of Razor Blade 110 arranged in a variety of configurations. For example, the device may contain 2, 3, 5, or any number of Razor Blade 110, which may be oriented with a sharp edge facing a side of Cartridge 100, for example, the front side of Cartridge 100. In the example illustrated in FIG. 1, Cartridge 100 contains multiple Razor Blade 110 arranged in a parallel configuration. One of skill in the art would recognize that Razor Blade 110, when arranged in a parallel configuration, may be spaced at various distances from each other while maintaining functionality. For example, two adjacent parallel Razor Blade 110 may be positioned 0.5, 0.1, or 0.15 mm apart; however, any separating distance may be used to maintain desired functionality of the razor.

In this example, Cartridge 100 may be inserted into Cartridge Receptacle 130. Cartridge 100 may be of various shapes and configurations and may correspond to a shape or configuration of Cartridge Receptacle 130. As one non-limiting example, Cartridge 100 may be loop-shaped and may correspond to a loop-shaped portion of Cartridge Receptacle 130. Thus, loop-shaped Cartridge 100 may be inserted into the loop-shaped Cartridge Receptacle 130.

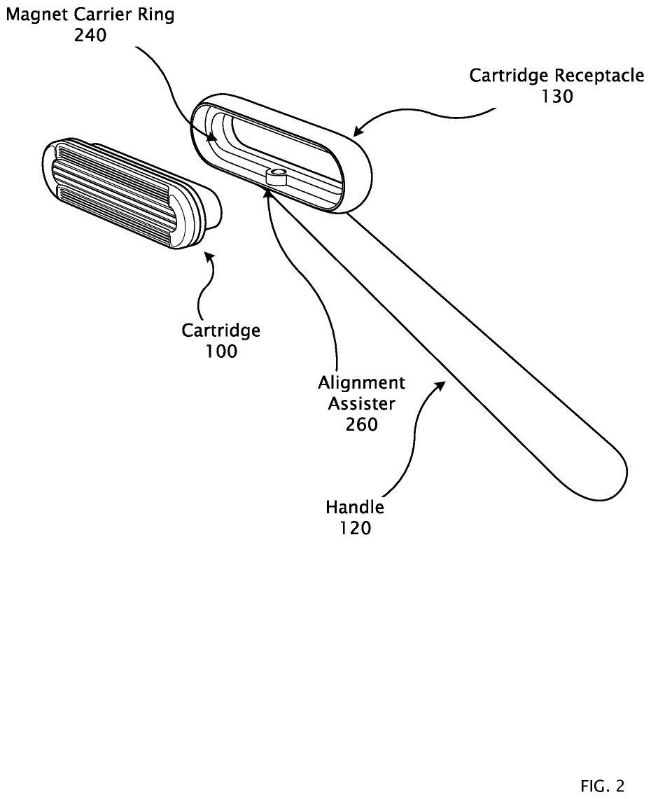

FIG. 2 illustrates a partially exploded view of an example of a razor. Magnet Carrier Ring 240 may be fixed to Cartridge Receptacle 130 to removably hold Cartridge 100 in place. Magnet Carrier Ring 240 may be provided that corresponds to a shape of Cartridge Receptacle 130. For example, if Cartridge Receptacle 130 is loop-shaped, Magnet Carrier Ring 240 may have a corresponding loop-shape such that Magnet Carrier Ring 240 may be inserted and fixed into loop-shaped Cartridge Receptacle 130. Magnet Carrier Ring 240 may have Alignment Assister 260, which may help guide Cartridge 100 into a proper position when inserting it into Cartridge Receptacle 130. Alignment Assister 260 may also have a spring to reduce play when Cartridge 100 is in Cartridge Receptacle 130.

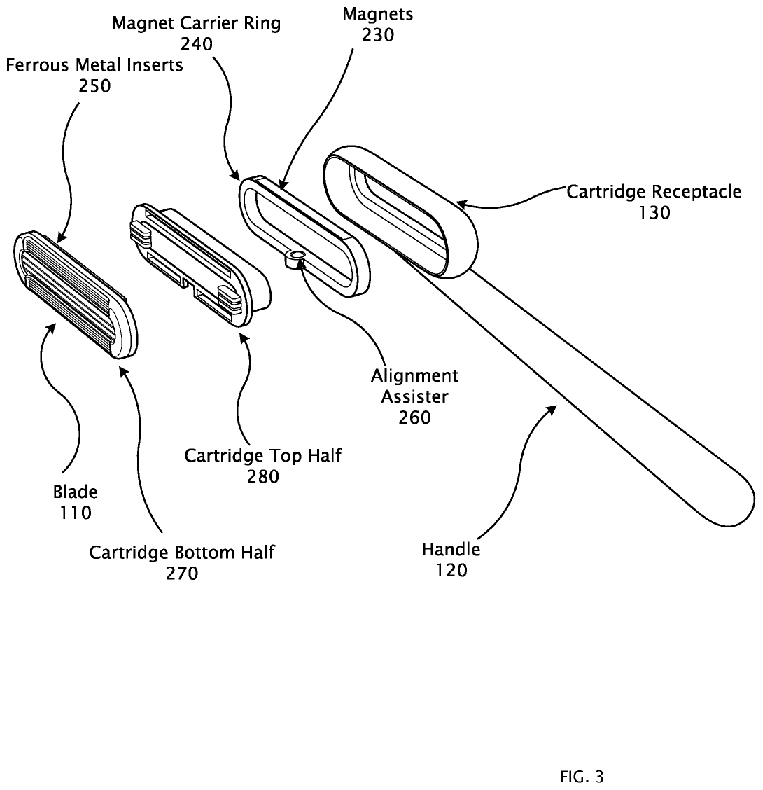

FIG. 3 illustrates another partially exploded view of an example of a razor. In this example, Magnet Carrier Ring 240 may be inserted into and attached to Cartridge Receptacle 130. The razor may include Cartridge Receptacle 130 or Magnet Carrier Ring 240 containing one or more Magnets 230 into which Cartridge 100, that may contain at least one Razor Blade 110, may be inserted into or attached. In one example, Magnet Carrier Ring 240 may have one or more coupled Magnets 230. Magnets 230 may comprise one or more magnet(s), positioned in various locations on Magnet Carrier Ring 240. For example, Magnets 230 may be positioned on an inside surface of Magnet Carrier Ring 240, an edge of Magnet Carrier Ring 240, or an outer surface of Magnet Carrier Ring 240. In another example, Magnets 230 may be placed on a left side of Magnet Carrier Ring 240, and another Magnets 230 may be placed on a right side of Magnet Carrier Ring 240. Alternatively, Magnets 230 may be placed on any other surface of Magnet Carrier Ring 240. In this example, when Magnet Carrier Ring 240 is inserted into Cartridge Receptacle 130, Magnet Carrier Ring 240 may become secured within Cartridge Receptacle 130.

In yet another example, at least one Magnets 230 may be contained within Cartridge Receptacle 130. For example, Cartridge Receptacle 130 may contain Magnets 230 on a front or leading side of Cartridge Receptacle 130 or Magnets 230 on a back or trailing side of Cartridge Receptacle 130. In a further example, Cartridge Receptacle 130 may alternatively or additionally contain Magnets 230 on at least one side edge of Cartridge Receptacle 130.

In another example, Cartridge 100 may contain at least one Magnets 230. The shape of Cartridge 100 may correspond to a shape of Magnets 230 or Magnet Carrier Ring 240 that may be inserted into Cartridge Receptacle 130. For example, Cartridge 100 may have a loop-shaped configuration, Cartridge Receptacle 130 may be loop-shaped, and loop-shaped Magnet Carrier Ring 240 may be inserted into Cartridge Receptacle 130. In this example, Magnet Carrier Ring 240 may be located in a position that corresponds to at least one Ferrous Metal Inserts 250 in Cartridge 100. For example, Magnet Carrier Ring 240 may be loop-shaped and may further contain a plurality of Magnets 230 arranged around the perimeter of Cartridge 100. Alternatively, Magnet Carrier Ring 240 may be circular or ovoid in shape and may contain a plurality of magnetic components arranged around the circumference of Cartridge 100. Alternatively, Magnets 230 may be arranged in a Halbach array configuration; however, any configuration may be used within the scope of the instant disclosure. Further, the shape of Cartridge 100, Cartridge Receptacle 130, or Magnet Carrier Ring 240 are not so limited as any shape may be used. Cartridge 100 may comprise several sections, including Cartridge Top Half 280 and Cartridge Bottom Half 270, which may be fixed together during a manufacturing process. Cartridge Bottom Half 270 may comprise Ferrous Metal Inserts 250, which may hold Cartridge 100 in place in conjunction with Magnet Carrier Ring 240.

In one example, Cartridge Receptacle 130 may contain Magnets 230 arranged in a Halbach array configuration. This arrangement may provide a strong magnetic force from Magnets 230 while limiting the size of the magnets to a manageable size. Hence, in this example, the size of Handle 120 may be minimized while providing the capability of Handle 120 to house a desired number of Magnets 230 to provide a desired level of magnetic force. Alternatively, Magnet Carrier Ring 240 may contain a plurality of Magnets 230 arranged in a Halbach array configuration, and Magnet Carrier Ring 240 may be inserted into Cartridge Receptacle 130 to provide a desired magnetic force. A corresponding Cartridge 100 may also be provided containing one or more Magnets 230. The one or more Magnets 230 of Cartridge 100 may further be configured in a Halbach array configuration corresponding to the one or more Magnets 230 of Cartridge Receptacle 130 or Magnet Carrier Ring 240.

In another example, Cartridge 100 may be attached to Handle 120 such that at least one Razor Blade 110 contained therein is configured in a desired orientation. For example, Handle 120 or Magnetic Carrier Ring 240 may include Alignment Assister 260 for receiving Cartridge 100 such that when Cartridge 100 is inserted into Cartridge Receptacle 130, Razor Blade 110 contained within Cartridge 100 are oriented perpendicular to Handle 120. In addition to or alternatively, Razor Blade 110 may be angled as desired when Cartridge 100 is inserted via Alignment Assister 260 of Handle 120.

Also, the alignment structure may contain, for example, a component for distributing forces applied to the device during use such that the forces may be distributed in a desired fashion. In one example, Alignment Assister 260 may contain a spring that is subject to forces applied to the device and distributes the applied force in a horizontal direction with respect to Cartridge 100. Alternatively, Alignment Assister 260 may distribute forces in a vertical orientation or skewed orientation with respect to Cartridge 100.

In yet another example, Cartridge 100 may be disconnected from Handle 120. For example, pressure may be applied to a front edge of Cartridge 100 to release Cartridge 100 from Handle 120. Alternatively, pressure may be applied to a back edge or a side edge of Cartridge 100. In another example, pressure may be applied to a corner aspect of Cartridge 100 to release Cartridge 100 from Handle 120.

The shape of Magnet Carrier Ring 240 may correspond to the shape of Cartridge Receptacle 130 in this example. The Magnet Carrier Ring 240 may contain a plurality of Magnets 230. In this example, Magnets 230 may be arranged on a side of a loop-shaped Magnet Carrier Ring 240, which corresponds to a loop-shaped Cartridge Receptacle 130.

The razor may further contain Cartridge Top Half 280 that corresponds in shape to Magnet Carrier Ring 240 and Cartridge Receptacle 130. Cartridge 100 may further include at least one Magnets 230 arranged around the periphery of Magnet Carrier Ring 240. At least one Razor Blade 110 may be inserted into Cartridge Top Half 280. FIG. 2 also illustrates an example in which Razor Blade 110 is attached to Cartridge Top Half 280 and Cartridge Bottom Half 270 to form Cartridge 100 that may be inserted into Magnet Carrier Ring 240 in Cartridge Receptacle 130.

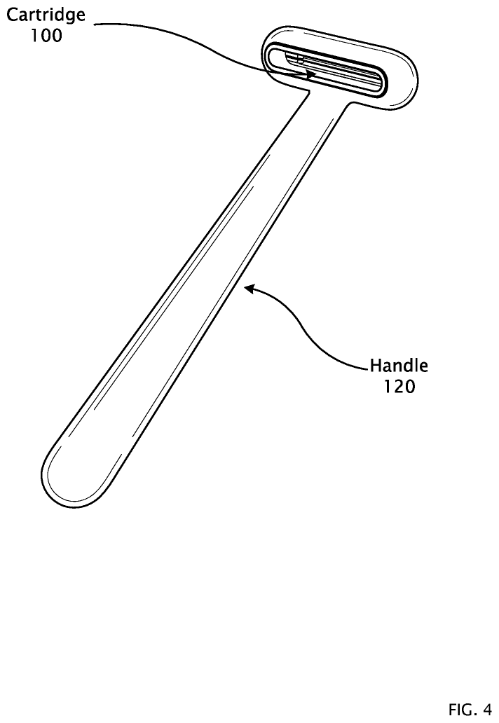

FIG. 4 illustrates another example in which a cartridge is inserted into a handle. Handle 120 may contain Alignment Assister 260 that permits proper alignment of Cartridge 100 and the at least one Razor Blade 110. Alignment Assister 260 may further contain a spring of similar structure to distribute applied forces to the device in a desired orientation, such as in a horizontal orientation with respect to Cartridge 100. In addition, as the example of FIG. 4 illustrates, Cartridge 100 may be cleanly attached to the handle in a way that is both functional and secure.

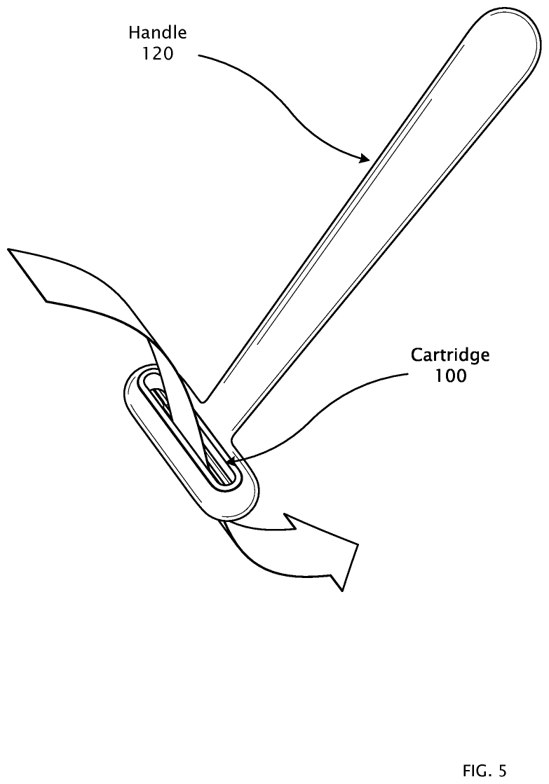

FIG. 5 illustrates a potential flow of water or air to assist in cleaning hair from a razor, according to one embodiment. There may be a gap between Cartridge 100 and Handle 120 when Cartridge 100 is disposed within Handle 120, which may allow for rinsing hair or other contaminants out using water or compressed air, for example.

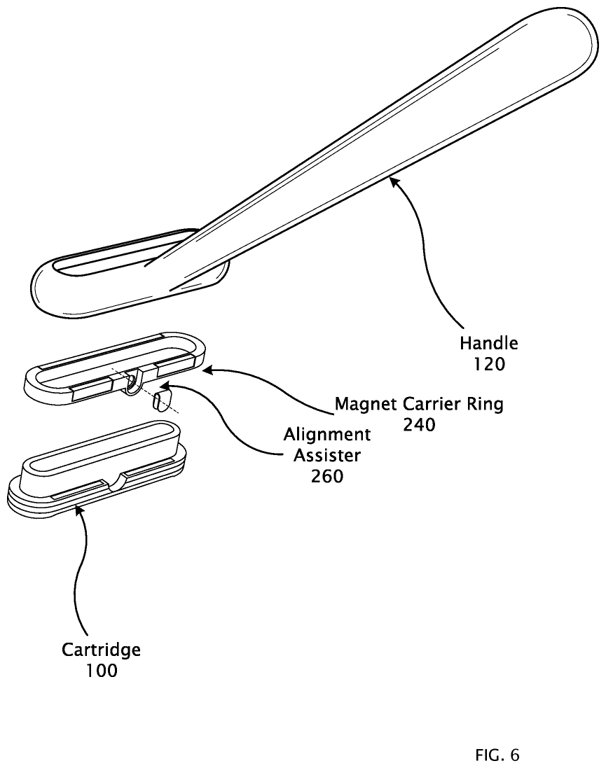

FIG. 6 illustrates another view of a partially assembled razor, according to one embodiment.

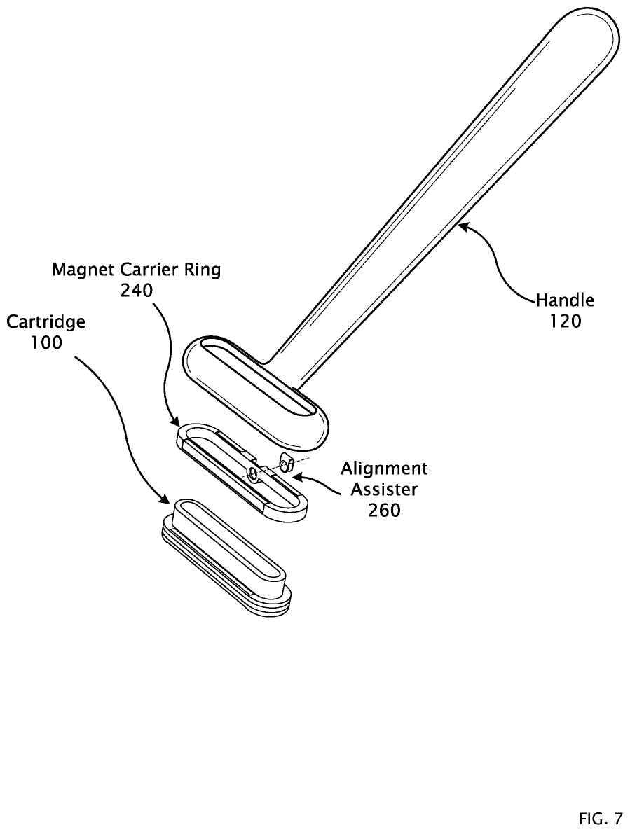

FIG. 7 illustrates another view of a partially assembled razor, according to one embodiment.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A razor comprising:
a cartridge including at least one ferrous metal component, and
a handle,
wherein the cartridge removably attaches to the handle via at least one magnetic component.

2. The razor of claim 1, wherein the at least one magnetic component inserts into and attaches to the handle.

3. The razor of claim 2, wherein the at least one magnetic component includes at least one magnet that corresponds to the at least one ferrous metal component of the cartridge.

4. The razor of claim 3, wherein the at least one magnetic component includes a plurality of magnets arranged in a Halbach array configuration, the cartridge removably attaching to the handle via the plurality of magnets.

5. The razor of claim 3, wherein the handle comprises an alignment structure wherein the cartridge attaches to the handle when aligned with the alignment structure.

6. The razor of claim 5, wherein the alignment structure further comprises a spring for distributing forces.

7. A shaving cartridge for connecting to a handle, the cartridge comprising:
at least one razor blade; and
at least one ferrous metal component.

8. The shaving cartridge of claim 7 further comprising a plurality of ferrous metal components.

9. The shaving cartridge of claim 8, wherein the plurality of magnetic components are arranged in a Halbach array configuration.

10. A shaving handle for connecting to a shaving cartridge, the shaving handle comprising:
a magnetic portion; and
a handle portion.

11. The shaving handle of claim 10, wherein the magnetic portion includes at least one magnet for attaching to the shaving cartridge.

12. The shaving handle of claim 10, wherein the magnetic portion includes a plurality of magnets arranged in a Halbach array configuration.

13. The shaving handle of claim 12, further comprising an alignment structure for attaching to the shaving cartridge.

14. The shaving handle of claim 13, wherein the alignment structure further comprises a component for distributing applied forces.

15. The shaving handle of claim 14, wherein the component for distributing applied forces comprises a spring.
